(19) United States
(12) Patent Application Publication
(10) Pub. No.: US 2026/0074365 A1
(43) Pub. Date: Mar. 12, 2026

(54) POWER STORAGE MODULE

(71) Applicant: KABUSHIKI KAISHA TOYOTA JIDOSHOKKI, Aichi (JP)

(72) Inventors: Makoto SAKAGUCHI, Aichi (JP); Taku INOUE, Aichi (JP); Kojiro TAMARU, Aichi (JP)

(73) Assignee: KABUSHIKI KAISHA TOYOTA JIDOSHOKKI, Aichi (JP)

(21) Appl. No.: 19/135,283

(22) PCT Filed: Oct. 20, 2023
(86) PCT No.: PCT/JP2023/038009

§ 371 Date: Jun. 3, 2025

(30) Foreign Application Priority Data
Dec. 12, 2022 (JP) 2022-197779

(51) Int. Cl. H01M 50/392; H01G 2/10; H01M 10/0525; H01M 10/34; H01M 50/325; H01M 50/358

(52) U.S. Cl. CPC H01M 50/392; H01G 2/10; H01M 10/0525; H01M 10/345; H01M 50/325; H01M 50/358

(57) ABSTRACT

A power storage module includes a module main body having an electrode stack in which a plurality of electrodes are stacked; and a pressure control valve attached to the module main body. The pressure control valve includes a housing having a first wall that has a communication hole, a second wall, and a first protrusion formed in the second wall, and a valve body accommodated in the housing so as to close the communication hole. The second wall has a first hole that is opened at an outer surface of the second wall, and a second hole that is opened at the outer surface, the second hole being positioned vertically above the first hole. The first protrusion protrudes outward from the outer surface along a first direction, and extends so as to partition between the first hole and the second hole, as viewed in the first direction.

### TECHNICAL FIELD

The present disclosure relates to a power storage module.

### BACKGROUND ART

Patent Document 1 discloses a power storage module. The power storage module includes a module main body including an electrode stack formed by stacking a plurality of electrodes, and a pressure control valve attached to the module main body. The pressure control valve includes a housing and a valve is body accommodated in the housing. The housing has a communication hole that is formed between the electrodes and is in communication with an internal space in which an electrolyte is contained, and an outlet port for discharging gas that is generated from the electrodes and flows into the housing from the internal space through the communication hole.

### CITATION LIST

### Patent Literature

[Patent Document 1] Japanese Patent Application Publication No. 2021-9794

### SUMMARY OF THE INVENTION

### Technical Problem

In the above pressure control valve, when gas is discharged from the outlet port, the electrolyte may be discharged together with gas. In this case, there is a risk that the electrolyte will be scattered by gas.

An object of the present disclosure is to provide a power storage module capable of suppressing scattering of an electrolyte.

### Solution to Problem

A power storage module according to one aspect of the present disclosure includes a module main body having an electrode stack in which a plurality of electrodes are stacked, and a pressure control valve attached to the module main body. The pressure control valve includes: a housing having a first wall that has a communication hole in communication with an internal space formed between the electrodes, the internal space containing electrolyte, a second wall facing the first wall in a first direction that intersects with a vertical direction, and a first protrusion formed in the second wall, and a valve body accommodated in the housing so as to close the communication hole. The second wall has a first hole that provides communication between an inside and an outside of the housing and is opened at an outer wall surface of the second wall, and a second hole that provides communication between the inside and the outside of the housing, is opened at the outer wall surface, and is positioned vertically above the first hole. The first protrusion protrudes outward from the outer wall surface along the first direction, and extends so as to partition between the first hole and the second hole, as viewed in the first direction.

In the above-mentioned power storage module, the first hole and the second hole positioned vertically above the first hole are provided in the outer surface of the second wall of the housing. Therefore, the electrolyte is discharged in a dripping manner from the first hole positioned vertically below. On the other hand, since gas such as hydrogen gas and oxygen gas generated in the power storage module is lighter than air, the gas is discharged from the second hole positioned vertically above. In addition, the first protrusion protrudes outward from the outer surface of the second wall, and extends so as to partition between the first hole and the second hole. In other words, the first protrusion is provided so as to be interposed between a discharge path for electrolyte discharged from the first hole and a discharge path for gas discharged from the second hole. Therefore, gas discharged from the second hole is blocked by the first protrusion and is less likely to blow against the electrolyte discharged from the first hole. Accordingly, it is possible to suppress scattering of electrolyte.

As viewed in the first direction, a length of the first protrusion in a second direction intersecting with the vertical direction is equal to or greater than a length of the first hole and a length of the second hole in the second direction, and as viewed in the first direction, the first protrusion may extend so as to entirely cover an upper side of the first hole and entirely cover a lower side of the second hole. In this case, since the first protrusion can entirely cover the upper side of the first hole and the lower side of the second hole, gas discharged from the second hole is further less likely to blow against electrolyte discharged from the first hole. This further suppresses scattering of electrolyte.

The first hole and the second hole may be arranged so as not to overlap with each other in the vertical direction. In this case, blowing of gas discharged from the second hole against electrolyte discharged from the first hole may be further suppressed.

The housing may further include a plurality of second protrusions that protrude from the outer surface so that the second protrusions and the first protrusion cooperate to surround each of the first hole and the second hole. In this case, gas discharged from the second hole is less likely to spread to the surroundings. As a result, blowing of gas discharged from the second hole against electrolyte discharged from the first hole may be further suppressed.

The internal space may include a plurality of internal spaces, the communication hole may include a plurality of communication holes arranged in a third direction intersecting with the vertical direction as viewed in the first direction, the plurality of the communication holes being in communication with their associated plurality of the internal spaces, and the second hole may include a plurality of second holes arranged in the third direction. In this case, not only the plurality of communication holes are arranged in the third direction, but the plurality of second holes are also arranged in the third direction, so that a path from each of the communication holes to the associated one of the second holes can be shortened. This suppresses discharging of gas, which has flowed in from the communication holes, through the first holes which are disposed in the middle of the paths to second holes.

The first holes may be arranged in the third direction intersecting with the vertical direction when as viewed in the first direction. In this case, an amount of electrolyte discharged from the first holes is reduced. This prevents a short circuit between power storage modules disposed side by side through electrolyte discharged from the pressure control valve.

### Advantageous Effects of Invention

According to the present disclosure, it is possible to provide a power storage module capable of suppressing scattering of electrolyte.

### BRIEF DESCRIPTION OF DRAWINGS

FIG. 1 is a cross-sectional view, illustrating a power storage device including a power storage module according to an embodiment.

FIG. 2 is a cross-sectional view, taken along line II-II of FIG. 1.

FIG. 3 is a cross-sectional view, illustrating the power storage module.

FIG. 4 is a perspective view, illustrating the power storage module.

FIG. 5 is an exploded perspective view, illustrating a part of the power storage module.

FIG. 6 is an exploded perspective view, illustrating a pressure control valve.

FIG. 7 is a bottom view of the pressure control valve.

FIG. 8 is a plan view of a case.

FIG. 9 is a plan view of a cover.

FIG. 10 is an enlarged plan view illustrating a portion of the cover.

FIG. 11 is a plan view of the pressure control valve.

FIG. 12 is a cross-sectional view, taken along line XII-XII of FIG. 11.

### DESCRIPTION OF EMBODIMENTS

The following will describe an embodiment of the present disclosure in detail with reference to the accompanying drawings. In the description of the drawings, the same reference signs are used for the same or equivalent parts, and the repeated descriptions are omitted. In the drawings, a XYZ Cartesian coordinate system may be shown as required. In one example, the Z-axis direction is a vertical direction, and the X-axis direction (second and third directions) and the Y-axis direction (first direction) are horizontal directions.

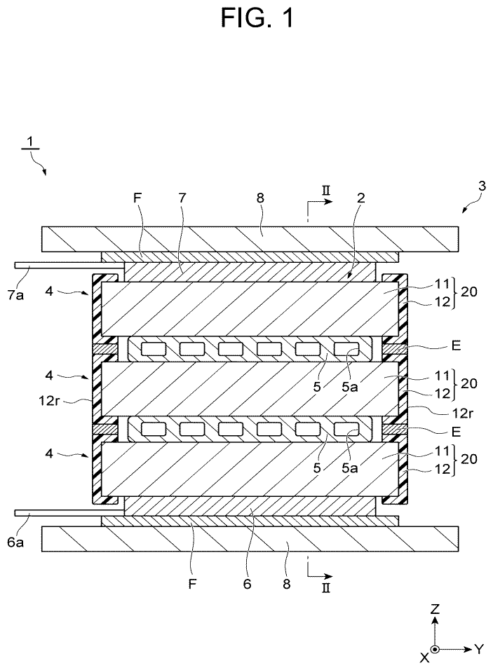

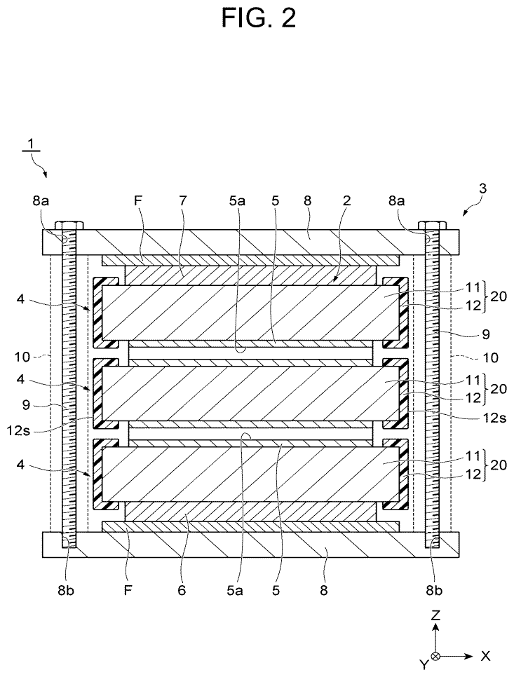

FIG. 1 is a cross-sectional view, illustrating a power storage device including a power storage module according to an embodiment. FIG. 1 illustrates a cross-section perpendicular to the X-axis direction. FIG. 2 is a cross-sectional view, taken along line II-II of FIG. 1. FIG. 2 illustrates a cross-section perpendicular to the Y-axis direction. A power storage device 1 illustrated in FIGS. 1 and 2 may be used as a battery for various vehicles such as a forklift truck, a hybrid vehicle, and an electric vehicle. The power storage device 1 includes a module stack 2 in which a plurality of power storage modules 4 are stacked along the Z-axis direction, and a constraining member 3 that applies a constraint load to the module stack 2 along the Z-axis direction.

The module stack 2 includes a plurality of power storage modules 4 (three power storage modules 4 in the present embodiment), and a plurality of conductive plates 5 (two conductive plates 5 in the present embodiment). The power storage modules 4 each are, for example, a bipolar battery, and has a rectangular shape as viewed in the Z-axis direction. More specifically, the power storage modules 4 each have a rectangular shape having long sides and short sides as viewed in the Z-axis direction. The power storage modules 4 each are, for example, a secondary battery such as a nickel-metal hydride battery, a lithium-ion battery, and a lead battery, or an electric double layer capacitor. In the following description, the nickel-hydrogen secondary battery will be described as an example.

In the module stack 2, the conductive plates 5 are interposed between the power storage modules 4 disposed side by side along the Z-axis direction. As a result, the plurality of power storage modules 4 are electrically connected via the conductive plates 5. More specifically, the power storage modules 4 each have a positive terminal surface on one end surface in the Z-axis direction and a negative terminal surface on the other end surface in the Z-axis direction, and the power storage modules 4, which are stacked with the conductive plates 5 interposed therebetween, are connected in series. A current collector plate 6 from which a positive terminal 6a is drawn out is disposed outside one of the power storage modules 4 positioned on one end of the module stack 2 in the Z-axis direction, and is electrically connected to such one of the power storage modules 4. A current collector plate 7 from which a negative terminal 7a is drawn out is disposed outside one of the power storage modules 4 positioned on the other end of the module stack 2 in the Z-axis direction, and is electrically connected to such one of the power storage modules 4. The power storage device 1 is charged and discharged using the positive terminal 6a and the negative terminal 7a.

Inside the conductive plates 5, a plurality of flow paths 5a are provided for circulating refrigerant such as air. For example, the flow paths 5a extend along a direction (the X-axis direction in the present embodiment) that crosses (perpendicularly) the Z-axis direction and a drawn-out direction in which the positive terminal 6a and the negative terminal 7a are drawn out. The conductive plates 5 each function as a connecting member that electrically connects the power storage modules 4 to each other, and also function as a heat dissipation member that allows refrigerant to circulate through the flow paths 5a to dissipate heat generated in the power storage modules 4.

The constraining member 3 includes a pair of constraining plates 8 between which the module stack 2 is sandwiched in a stacking direction, a plurality of fastening members 9 such as bolts that connect the constraining plates 8 to each other by fastening, and pillars 10 each accommodating a body portion (e.g., a shaft of a bolt) of its associated fastening member 9. The constraining plates 8 each are a metal plate having a rectangular shape, the area of which is greater than the area of each of the power storage modules 4 and the conductive plates 5 as viewed in the first direction. The constraining plates 8 each have a rectangular shape having long sides and short sides as viewed in the Z-axis direction. An insulating member F having a plate shape is provided on an inner surface (a surface on the module stack 2 side) of each of the constraining plates 8. That is, the current collector plate 6 or the current collector plate 7, and the insulating member F are interposed between the module stack 2 and each of the constraining plates 8. This provides insulation between the constraining plates 8 and the module stack 2 (the current collector plates 6, or the current collector plate 7).

In an edge portion of one of the constraining plates 8, insertion holes 8a are formed at positions outward relative to the module stack 2 as viewed in the Z-axis direction, and in an edge portion of the other of the constraining plates 8, threaded holes 8b are formed at positions corresponding to the insertion holes 8a. The fastening members 9 are inserted from the insertion holes 8a of the one of the constraining plates 8 into the threaded holes 8b of the other of the constraining plates 8, and screwed into the threaded holes 8b of the other of the constraining plates 8. As a result, the power storage modules 4 and the conductive plates 5 are sandwiched between the constraining plates 8 and unitized as the module stack 2, and a constraint load is applied to the module stack 2 in the Z-axis direction.

In this way, the fastening members 9 are disposed outside the module stack 2 (a second seal portion 12, which will be described later), extend along the Z-axis direction, and fasten the pair of constraining plates 8 to each other in the Z-axis direction, thereby constraining the module stack 2 (an electrode stack 11, which will be described later). The pillars 10 are interposed between the pair of constraining plates 8 and extend along the Z-axis direction together with the fastening members 9. The pillars 10 define a distance between the pair of constraining plates 8 in the Z-axis direction, thereby defining a constraint force applied to the module stack 2.

In the power storage device 1, a plurality of connection members each including one fastening member 9 and one pillar 10 accommodating the one fastening member 9 are arranged along the long sides of the constraining plates 8 as viewed in the Z-axis direction. Additionally, the connection members face each other in a direction along the short sides of the constraining plates 8 as viewed in the Z-axis direction. As the connection members facing each other become closer to each other, a constraint load may be applied more evenly to the power storage modules 4 through the constraining plates 8.

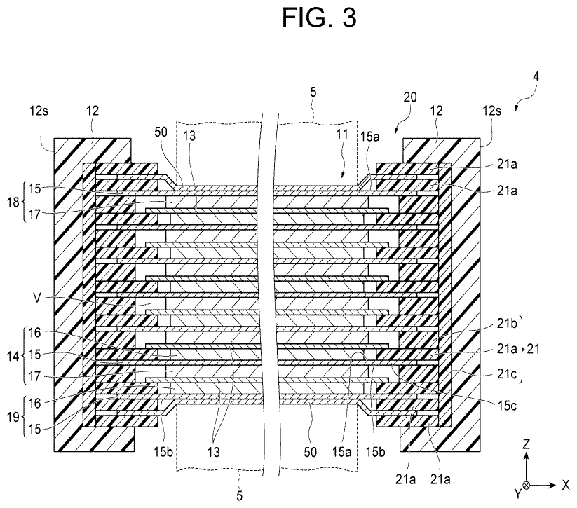

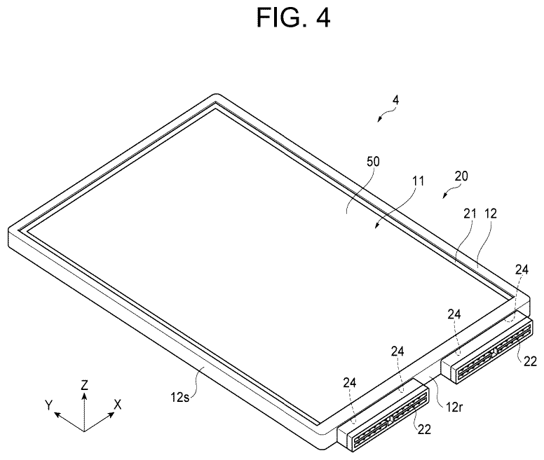

Next, the configuration of the power storage modules 4 will be described in detail. FIG. 3 is a cross-sectional view, illustrating the power storage module. FIG. 4 is a perspective view, illustrating the power storage module. As illustrated in FIGS. 3 and 4, the power storage modules 4 each include a module main body 20 and pressure control valves 22 attached to the module main body 20. The module main body 20 includes the electrode stack 11 and the second seal portion 12 made of resin and sealing the electrode stack 11. The electrode stack 11 includes a plurality of electrodes (a plurality of bipolar electrodes 14, one negative terminal electrode 18, and one positive terminal electrode 19) stacked along the Z-axis direction with separators 13 interposed therebetween. Here, a direction in which the electrodes are stacked coincides with the stacking direction of the power storage modules 4.

The bipolar electrodes 14 each include an electrode plate 15 having a first surface 15a and a second surface 15b opposite from the first surface 15a, a positive electrode active material layer 16 provided on the first surface 15a, and a negative electrode active material layer 17 provided on the second surface 15b. In the electrode stack 11, the positive electrode active material layer 16 of one of the bipolar electrodes 14 faces the negative electrode active material layer 17 of another of the bipolar electrodes 14 that is disposed side by side with the one of the bipolar electrodes 14 in the Z-axis direction with one of the separators 13 interposed therebetween. In the electrode stack 11, the negative electrode active material layer 17 of one of the bipolar electrodes 14 faces the positive electrode active material layer 16 of another of the bipolar electrodes 14 that is disposed side by side with the one of the bipolar electrodes 14 in the Z-axis direction with one of the separators 13 interposed therebetween.

The negative terminal electrode 18 includes the electrode plate 15 and the negative electrode active material layer 17 provided on the second surface 15b of the electrode plate 15. No active material layer is provided on the first surface 15a of the electrode plate 15 of the negative terminal electrode 18. The negative terminal electrode 18 is disposed at one end of the electrode stack 11 in the Z-axis direction so that the second surface 15b of the negative terminal electrode 18 is on an inner side of the electrode stack 11 (a side facing the center in the Z axis direction). The negative electrode active material layer 17 of the negative terminal electrode 18 faces the positive electrode active material layer 16 of one of the bipolar electrodes 14 at the one end in the Z-axis direction with one of the separators 13 interposed therebetween.

The positive terminal electrode 19 includes the electrode plate 15, and the positive electrode active material layer 16 provided on the first surface 15a of the electrode plate 15. No active material layer is provided on the second surface 15b of the electrode plate 15 of the positive terminal electrode 19. The positive terminal electrode 19 is disposed at the other end of the electrode stack 11 in the Z-axis direction so that the first surface 15a of the positive terminal electrode 19 is on the inner side of the electrode stack 11. The positive electrode active material layer 16 of the positive terminal electrode 19 faces the negative electrode active material layer 17 of one of the bipolar electrodes 14 at the other end in the Z-axis direction with one of the separators 13 interposed therebetween.

The first surface 15a of the electrode plate 15 of the negative terminal electrode 18 is a surface facing an outside of the electrode stack 11. One of the conductive plates 5 is electrically connected to the first surface 15a of the negative terminal electrode 18 via a metal plate 50, which will be described later. The second surface 15b of the electrode plate 15 of the positive terminal electrode 19 is a surface facing the outside of the electrode stack 11. Another one of the conductive plates 5 is electrically connected to the second surface 15b of the positive terminal electrode 19 via the metal plate 50, which will be described later.

The electrode plates 15 each are made of a metal such as nickel or a nickel-plated steel plate. In one example, the electrode plates 15 each are a rectangular metal foil made of nickel. The electrode plates 15 each have a peripheral edge portion 15c (peripheral edge portions of the bipolar electrodes 14, the negative terminal electrode 18, and the positive terminal electrode 19) that has a rectangular frame shape and is an area where neither the positive electrode active material layer 16 nor the negative electrode active material layer 17 is formed. For example, nickel hydroxide is used as a positive electrode active material forming the positive electrode active material layer 16. For example, hydrogen storage alloy is used as a negative electrode active material forming the negative electrode active material layer 17.

The separators 13 each have a sheet shape, for example. For example, a porous film made of a polyolefin-based resin such as polyethylene (PE) or polypropylene (PP), a woven fabric or a nonwoven fabric made of polypropylene, polyethylene terephthalate (PET), methylcellulose, or the like may be used for the separators 13. The separators 13 may be reinforced with a vinylidene fluoride resin compound.

The electrode stack 11 includes a plurality of first seal portions 21 made of an insulating resin. The first seal portions 21 each include a first portion 21a, a second portion 21b, and a third portion 21c. The first portion 21a has a rectangular frame shape as viewed in the Z-axis direction, and is connected (e.g., welded) to the peripheral edge portion 15c of each of the electrode plates 15. The second portion 21b has a rectangular frame shape as viewed in the Z-axis direction, and is disposed on a portion of the first portion 21a. That is, as viewed in the Z-axis direction, an inner edge of the second portion 21b is located outward relative to an inner edge of the first portion 21a. A peripheral edge portion of each of the separators 13 is connected (e.g., welded) to the first portion 21a.

The third portion 21c has a rectangular tubular shape extending along the Z-axis direction, and connect the first portions 21a with the second portions 21b to each other so as to be integrated. The first portions 21a and the second portion 21b may be formed by folding a single sheet member, for example. In this case, the third portion 21c is a welding end portion formed by welding folded portion of the sheet member (outer ends of the first portions 21a and the second portion 21b), for example.

The second seal portion 12 is made of, for example, an insulating resin, and has a generally rectangular tubular shape. The second seal portion 12 is provided around the electrode stack 11 so as to surround the electrode stack 11. The second seal portion 12 is connected (e.g., welded) to the first seal portions 21 so as to surround the first seal portions 21 from the outside. The second seal portion 12 is formed, for example, by injection molding of resin, and extends over the entire length of the electrode stack 11 along the Z-axis direction. The second seal portion 12 is welded to outer surfaces of the first seal portions 21, for example, by heat generated at the injection molding.

The first seal portions 21 and the second seal portion 12 provide sealing between the bipolar electrodes 14 disposed side by side along the Z-axis direction, between the negative terminal electrode 18 and one of the bipolar electrodes 14, and between the positive terminal electrode 19 and one of the bipolar electrodes 14. Thus, internal spaces V, which are hermetically partitioned, are formed between the bipolar electrodes 14, between the negative terminal electrode 18 and one of the bipolar electrodes 14, and between the positive terminal electrode 19 and one of the bipolar electrodes 14. That is, the first seal portions 21 and the second seal portion 12 are provided for forming the internal spaces V between the electrodes and for sealing of the internal spaces V. The internal spaces V each contain an electrolyte (not illustrated) made of an alkaline solution such as an aqueous solution of potassium hydroxide. At least a portion of the electrolyte is impregnated into the separators 13, the positive electrode active material layer 16, and the negative electrode active material layer 17.

The first seal portions 21 and the second seal portion 12 are made of, for example, an insulating resin, and may be made of polypropylene (PP), polyphenylene sulfide (PPS), modified polyphenylene ether (modified PPE), or the like.

As illustrated in FIGS. 1 to 4, the second seal portion 12 includes a pair of outer surfaces 12s and a pair of outer surfaces 12r connecting the outer surfaces 12s to each other. The outer surfaces 12s and the outer surfaces 12r are surfaces extending along the Z-axis direction. Here, the outer surfaces 12s are surfaces that intersect with (extend perpendicular to) the X-axis direction, and the outer surfaces 12r are surfaces that intersect with (extend perpendicular to) the Y-axis direction. Furthermore, a length of each of the outer surfaces 12s in the Y-axis direction is longer than a length of each of the outer surfaces 12r in the X-axis direction. In the above-described conductive plates 5, the flow paths 5a extend along the X-axis direction and are opened at a pair of surfaces of the conductive plate 5 which intersect with the X-axis direction.

Therefore, gaps on the outer surfaces 12s side of the second seal portion 12 of the power storage modules 4 adjacent to each other are used for introducing and discharging refrigerant into and from the flow paths 5a (refrigerant passes through the gaps). On the other hands, gaps on the outer surfaces 12r side of the second seal portion 12 of the power storage modules 4 adjacent to each other are not used for introducing and discharging refrigerant into and from the flow paths 5a. Therefore, in the module stack 2, the gaps on the outer surfaces 12s side of the second seal portion 12 of the power storage modules 4 adjacent to each other are opened, and the gaps on the outer surfaces 12r side are sealed with a sealing material E.

Here, the power storage modules 4 each may include a pair of metal plates 50. In the present embodiment, the metal plates 50 are provided at one end (an end on the negative terminal electrode 18 side) and the other end (an end on the positive terminal electrode 19 side) of the electrode stack 11 in the Z-axis direction. One of the pair of metal plates 50 is in contact with the first surface 15a of the electrode plate 15 of the negative terminal electrode 18 and its associated one of the conductive plates 5. The other of the pair of metal plates 50 is in contact with the second surface 15b of the electrode plate 15 of the positive terminal electrode 19 and its associated one of the conductive plates 5. In this manner, in the power storage modules 4, the metal plates 50 are provided further outside the negative terminal electrode 18 and the positive terminal electrode 19. One of the metal plates 50 disposed at one end in the Z-axis direction (on the negative terminal electrode 18 side) serves as a negative terminal surface of each of the power storage modules 4. The other of the metal plates 50 disposed at the other end in the Z-axis direction (on the positive terminal electrode 19 side) serves as a positive terminal surface of each of the power storage modules 4.

A peripheral edge portion of one of the pair of metal plates 50 is held between one first portion 21a of one of the first seal portions 21 provided on the electrode plate 15 of the negative terminal electrode 18 and another first portion 21a facing the one first portion 21a. These paired first portions 21a are connected (e.g., welded) together with the third portion 21c. A peripheral edge portion of the other of the pair of metal plates 50 is held between one first portion 21a of one of the first seal portions 21 provided on the electrode plate 15 of the positive terminal electrode 19 and another first portion 21a facing the one first portion 21a. These paired first portions 21a are also connected (e.g., welded) together with the third portion 21c. The metal plates 50 each are a metal foil (uncoated foil) corresponding to the electrode plate 15 having no active material layer.

As illustrated in FIG. 4, one of the outer surfaces 12r of the second seal portion 12 is provided with a plurality of attaching regions 24 (four in the present embodiment) for attaching the pressure control valves 22. The attaching regions 24 are spaced from one another in the X-axis direction. In one example, one pressure control valve 22 is attached to two attaching regions 24 disposed side by side in the X-axis direction.

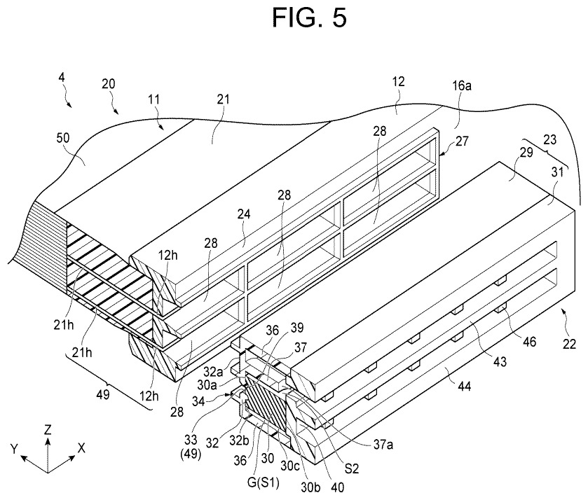

FIG. 5 is an exploded perspective view illustrating a part of the power storage module. As illustrated in FIG. 5, the second seal portion 12 has through holes 12h that extend through the second seal portion 12 in the Y-axis direction in each of the attaching regions 24. The first seal portions 21 have through holes 21h, respectively, that extend through the first seal portions 21 in the Y-axis direction and connect the through holes 12h to the internal spaces V (see FIG. 3). The attaching regions 24 each are provided with a plurality of through holes 12h (six through holes 12h in the present embodiment). The through holes 12h are arranged in two rows so that each row has three through holes 12h (three through holes in the X-axis direction, two through holes in the Z-axis direction) in each of the attaching regions 24. Thus, the through holes 12h are arranged in two rows so that each row has twelve through holes 12h in one of the outer surfaces 12r.

In the first seal portions 21, the through holes 21h are formed in an area corresponding to each of the attaching regions 24 so as to correspond to their associated through holes 12h in one-to-one relation. The through holes 21h are provided in the same number as that of the through holes 12h. The through holes 21h are in communication with their associated internal spaces V of different cells. The through holes 12h and the through holes 21h function as injection holes for injecting electrolyte into the internal spaces V. After electrolyte is injected, the through holes 12h and the through holes 21h become flow paths through which gas generated in the internal spaces V (for example, hydrogen gas in a case of a nickel-metal hydride battery) flows.

A connecting protrusion 27 having a substantially frame shape is formed in an outer surface of each of the attaching regions 24 of the second seal portion 12. The connecting protrusion 27 connects the module main body 20 with the associated one of the pressure control valves 22, and the connecting protrusion 27, the through holes 12h, and the through holes 21h cooperate to form a plurality of flow paths 28 (six flow paths 28 in the present embodiment) through which gas from the internal spaces V flows. Thus, the flow paths 28 are arranged in two rows so that each row includes three flow paths 28 in each of the attaching regions 24. The flow paths 28 each have a rectangular shape in a cross section along a plane perpendicular to the Y-axis direction. The connecting protrusion 27 has a lattice shape as viewed in the Y-axis direction.

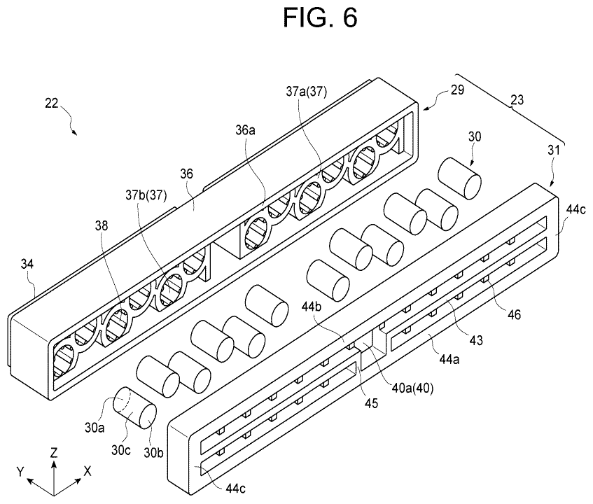

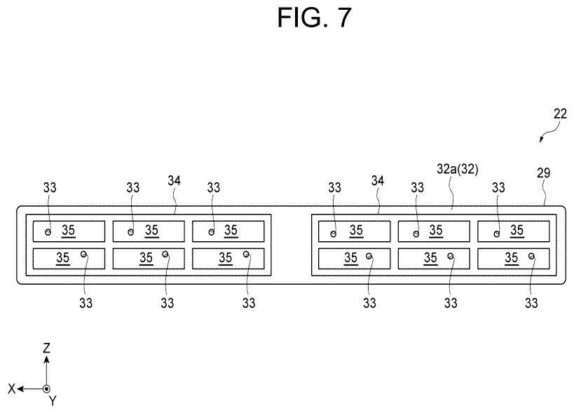

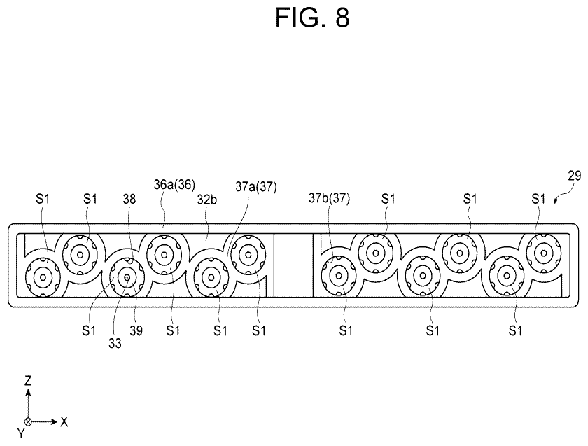

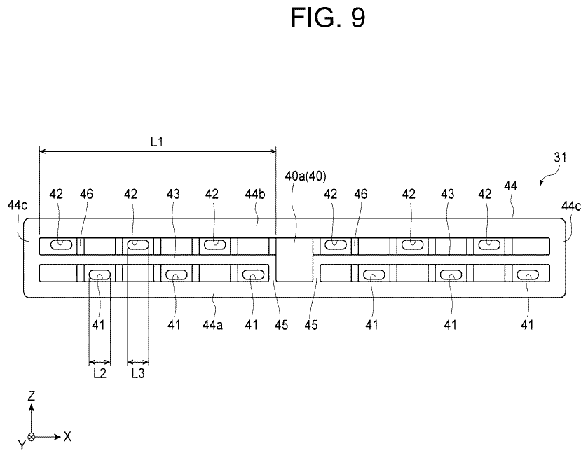

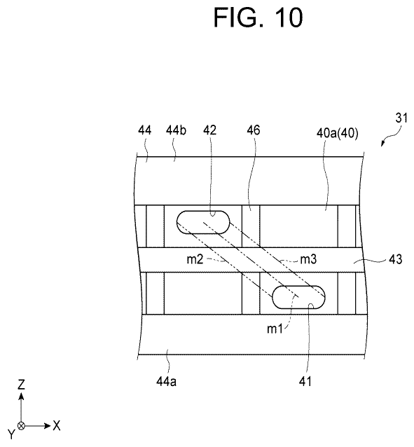

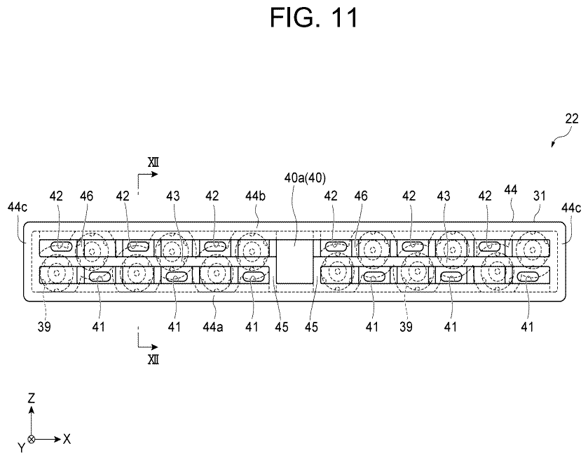

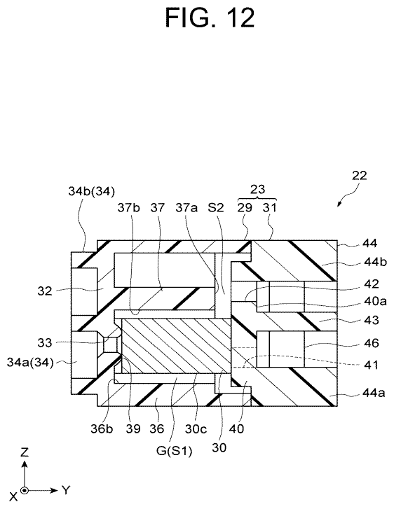

Next, the configuration of the pressure control valves 22 attached to the module main body 20 will be described in detail. FIG. 6 is an exploded perspective view, illustrating the pressure control valve. FIG. 7 is a bottom view of the pressure control valve. FIG. 8 is a plan view of a case. FIG. 9 is a plan view of a cover. FIG. 10 is an enlarged plan view, illustrating a portion of the cover. FIG. 11 is a plan view of the pressure control valve. FIG. 12 is a cross-sectional view, taken along line XII-XII of FIG. 11.

As illustrated in FIGS. 5 to 12, the pressure control valves 22 each have a housing 23 and a plurality of valve bodies 30 (twelve valve bodies 30 in the present embodiment). The housing 23 includes a case 29 and a cover 31. The case 29 is made of a resin such as PP, PPS, or modified PPE. The case 29 has a generally rectangular shape as viewed in a facing direction in which the case 29 faces the cover 31. The facing direction corresponds to an attaching direction in which the pressure control valves 22 are attached to one of the outer surfaces 12r of the module main body 20, and also to a compressing direction of the valve bodies 30, which will be described later. The pressure control valves 22 are attached to the module main body 20 in a direction perpendicular to the one of the outer surfaces 12r. Therefore, the facing direction in which the case 29 faces the cover 31 coincides with the Y-axis direction.

The case 29 has a bottom wall 32 (first wall). The bottom wall 32 faces one of the outer surfaces 12r of the module main body 20 in the Y-axis direction. The bottom wall 32 has a plurality (twelve in the present embodiment) of through holes 33 (communication holes) that extend through the bottom wall 32 in the Y-axis direction. The through holes 33 are arranged in the X-axis direction.

The through holes 33 extend from an outer wall surface 32a on the module main body 20 side to an inner wall surface 32b on the cover 31 side. The through holes 33 are connected to their associated through holes 12h of the module main body 20 through a space. Thus, the through holes 33, the through holes 12h, the through holes 21h cooperate to form a plurality of communication holes 49 in communication with the internal spaces V, respectively, of the module main body 20. In other words, the through holes 33, the through holes 12h, and the through holes 21h form portions of the communication holes 49. The through holes 33 correspond to outlets of the communication holes 49, and have a circular shape in a cross section perpendicular to the Y-axis direction (see FIG. 7). It can be said that the bottom wall 32 has the through holes 33 as portions of the communication holes 49 in communication with the internal spaces V that are formed between the electrodes of the module main body 20 and that contain electrolyte.

As illustrated in FIG. 7, a pair of connecting protrusions 34 each having a substantially frame shape is formed in the outer wall surface 32a of the bottom wall 32. The paired connecting protrusions 34 are spaced in the X-axis direction, at an interval corresponding to an interval between the connecting protrusions 27. The paired connecting protrusions 34 connect the module main body 20 with the pressure control valves 22, and form a plurality of flow paths 35 (twelve flow paths 35 in the present embodiment) through which gas and electrolyte from the internal spaces V flows. The connecting protrusions 34 are connected to the connecting protrusions 27 of the module main body 20. The connecting protrusions 34 each have a shape and dimensions corresponding to each of the connecting protrusions 27. Thus, the flow paths 35 each have a rectangular shape in a cross section along a plane perpendicular to the Y-axis direction. The connecting protrusions 34 each have a lattice shape as viewed in the Y-axis direction.

The module main body 20 and the pressure control valves 22 are connected, for example, by hot plate welding. Specifically, a hot plate is disposed between the module main body 20 and the pressure control valves 22, and tips of the connecting protrusions 27 and the connecting protrusions 34 are placed in contact with the hot plate. Thus, the tips of the connecting protrusions 27 and the connecting protrusions 34 are melted. Then, the tips of the connecting protrusions 34 are pressed against the tips of the connecting protrusions 27 while the connecting protrusions 27 and the connecting protrusions 34 are melted, so that the connecting protrusions 27 and the connecting protrusions 34 are welded (connected). As a result, the module main body 20 and the pressure control valves 22 are connected.

As illustrated in FIGS. 5 and 6, the case 29 has an outer peripheral wall 36 and partition walls 37, both protruding from the bottom wall 32 towards the cover 31. In the present embodiment, the outer peripheral wall 36 and the partition walls 37 are formed integrally with the bottom wall 32. The outer peripheral wall 36 is formed standing from an edge portion of the inner wall surface 32b of the bottom wall 32 so that the outer peripheral wall 36 surrounds the plurality of valve bodies 30 (twelve valve bodies 30 in the present embodiment) collectively. Specifically, the outer peripheral wall 36 extends over the entire outer peripheral edge of the bottom wall 32, and forms an outer wall of the case 29. More specifically, the outer peripheral wall 36 is formed in a substantially rectangular frame shape extending along the outer peripheral edge of the bottom wall 32 having a substantially rectangular frame shape as viewed in the Y-axis direction.

The partition walls 37 are formed standing from the inner wall surface 32b of the bottom wall 32 so as to cover side surfaces 30c of the valve bodies 30. In one example, the partition walls 37 form accommodation spaces S1 each having a columnar shape and accommodating each of the valve bodies 30. In the present embodiment, the partition walls 37 and portions of the outer peripheral wall 36 surround the side surfaces 30c of the valve bodies 30 to form the accommodation spaces S1. Furthermore, in the present embodiment, one of the partition walls 37 in which one of the valve bodies 30 is accommodated and another one of the partition walls 37 disposed adjacently thereto in which another one of the valve bodies 30 is accommodated are formed integrally. In this way, the partition walls 37 accommodating therein different valve bodies 30 may have a shared portion.

In the present embodiment, with respect to the inner wall surface 32b of the bottom wall 32, an end surface 36a of the outer peripheral wall 36 on the cover 31 side is disposed at a position higher than end surfaces 37a of the partition walls 37 on the cover 31 side in the Y-axis direction. Thus, in a state in which the cover 31 is fixed to the case 29, the cover 31 is in contact with the end surface 36a of the outer peripheral wall 36, whereas the cover 31 and the end surfaces 37a of the partition walls 37 are spaced from each other. That is, a space S2 is formed between the cover 31 and the end surfaces 37a of the partition walls 37. Such a space S2 functions as a flow path for gas and electrolyte flowing into insides of the pressure control valves 22 from the internal spaces V.

The valve bodies 30 are accommodated in the accommodation spaces S1 within the housing 23 so as to close the through holes 33. The valve bodies 30 are arranged in the X-axis direction so as to close their associated through holes 33. The valve bodies 30 each are a columnar member formed of an elastic member such as rubber. The valve bodies 30 each have a first end surface 30a that closes its associated one of the through holes 33 on the inner wall surface 32b side of the bottom wall 32, a second end surface 30b opposite from the first end surface 30a, and a side surface 30c that connects the first end surface 30a with the second end surface 30b. The second end surface 30b is a surface to be pressed by the cover 31.

The valve bodies 30 close the through holes 33 with the first end surfaces 30a pressed against the inner wall surface 32b of the bottom wall 32. The valve bodies 30 open and close the through holes 33 depending on pressures in the internal spaces V Gaps G are formed between the side surfaces 30c of the valve bodies 30 and inner wall surfaces 37b of the partition walls 37 or an inner wall surface 36b of the outer peripheral wall 36.

As illustrated in FIGS. 6 and 8, protruded portions 38 for positioning the valve bodies 30 are formed in the inner wall surfaces 37b of the partition walls 37. The protruded portions 38 protrude radially inwardly from the inner wall surfaces 37b of the partition walls 37. The protruded portions 38 extend over the entire inner wall surfaces 37b of the partition walls 37 along a direction in which a central axis of each of the through holes 33 extends (Y-axis direction). The protruded portions 38 are configured to be placed in contact with the side surfaces 30c of the valve bodies 30, respectively. With the protruded portions 38 placed in contact with the valve bodies 30, a central position of each of the valve bodies 30 and the central axis of its associated one of the through holes 33 may coincide with each other. The protruded portions 38 restrict displacement of the valve bodies 30 within a certain range. In the present embodiment, a plurality of protruded portions 38 (six protruded portions 38 in the present embodiment) are disposed at constant pitches around the central axis of each of the through holes 33.

As illustrated in FIG. 8, seal portions 39, which are protrusions protrude outward from the inner wall surface 32b, are formed in the inner wall surface 32b of the bottom wall 32 in the accommodation space S1. That is, the seal portions 39 are surrounded by the partition walls 37 as viewed in the Y-axis direction. Further, a plurality of seal portions 39 are collectively surrounded by the outer peripheral wall 36. As has been described, since one pressure control valve 22 is attached to the two attaching regions 24 in the configuration in one example, the seal portions 39 are disposed separately in one side and the other side of the center in the X-axis direction. The partition walls 37 surrounding the seal portions 39 disposed on the one side of the center in the X-axis direction, and the partition walls 37 surrounding the seal portions 39 disposed on the other side of the center in the X-axis direction are spaced from each other at the center in the X-axis direction. Therefore, the seal portions 39 adjacent to each other in the X-axis direction are arranged at positions shifted from each other in the Z-axis direction.

The seal portions 39 close clearances between the through holes 33 and the gaps G with the seal portions 39 placed in contact with the first end surfaces 30a of the valve bodies 30 pressed against the seal portions 39 so that the clearances may be opened and closed. The seal portions 39 are formed so as to surround open ends of the through holes 33 in the inner wall surface 32b. The seal portions 39 each are formed in an annular shape extending along an edge of its associated one of the through holes 33 around the central axis of the through hole 33. The seal portions 39 surround the entire circumferences of the through holes 33 without a gap. Accordingly, the seal portions 39 each are in contact with their associated one of the first end surfaces 30a of the valve bodies 30 without a gap, thereby securing airtightness.

The cover 31 illustrated in FIGS. 5, 6, and 9 to 12 is a member that closes an opening of the case 29. The cover 31 has a side wall 40 (second wall). The side wall 40 faces the bottom wall 32 of the case 29 in the Y-axis direction, across the valve bodies 30. The side wall 40 and the bottom wall 32 form a pair of walls of the housing 23 that face each other in the Y-axis direction. The cover 31 is made of a resin such as PP, PPS, or modified PPE. In one example, the cover 31 may be formed by injection molding. As viewed in the Y-axis direction, the position of the outer peripheral edge of the cover 31 substantially coincides with the position of the outer peripheral edge of the case 29 (the outer edge of the outer peripheral wall 36).

The cover 31 is connected to an open end surface of the case 29, for example, by welding such as ultrasonic welding. Specifically, the outer peripheral edge of the side wall 40 is welded to the end surface 36a of the outer peripheral wall 36 of the case 29. The side wall 40 has first holes 41 and second holes 42 that extend through the side wall 40 in the Y-axis direction. The first holes 41 and the second holes 42 provide communication between an inside and an outside of the housing 23, and are opened at an outer surface 40a of the side wall 40. The second holes 42 are positioned vertically above the first holes 41. The first holes 41 and the second holes 42 are arranged so as not to overlap with the valve bodies 30 as viewed in the Y-axis direction. The first holes 41 and the second holes 42 are disposed so as to be next to the valve bodies 30 in the Z-axis direction as viewed in the Y-axis direction. The first holes 41 and the second holes 42 are arranged so as not to overlap with each other in the vertical direction (Z-axis direction). The first holes 41 and the second holes 42 are spaced in the X-axis direction so as not to overlap with each other as viewed in the Z-axis direction.

The second holes 42 each are an outlet port (discharge port) for discharging (releasing) gas inside the pressure control valves 22 to an outside of the pressure control valves 22. The first holes 41 each are an outlet port for discharging electrolyte inside the pressure control valves 22 to the outside of the pressure control valves 22. Since the second holes 42 are positioned vertically above the first holes 41, gas such as hydrogen and oxygen that is generated in the module main body 20 and lighter than the atmosphere is discharged from the second holes 42. On the other hand, electrolyte is discharged from the first holes 41 in a dripping manner. In one example, the first holes 41 and the second holes 42 each have an elliptical shape with the X-axis direction as the longitudinal direction in a cross section perpendicular to the Y-axis direction. The first holes 41 and the second holes 42 have the same shape.

The side wall 40 is provided with a plurality of first holes 41 (six first holes 41 in the present embodiment) and a plurality of second holes 42 (six second holes 42 in the present embodiment). The first holes 41 are arranged in line in the X-axis direction. The second holes 42 are arranged in line in the X-axis direction. The first holes 41 and the second holes 42 are arranged alternately in the X-axis direction. Three first holes 41 and three second holes 42 are provided for each of the attaching regions 24 (see FIG. 4).

The outer surface 40a has an area in the center in the X-axis direction where the first holes 41 and the second holes 42 are not provided. This area corresponds to an area between the pair of attaching regions 24 on one of the outer surfaces 12r. In one example, identification information (not illustrated) is provided in this area. The identification information can be used for identifying the power storage modules 4. For example, the identification information may be a letter, a symbol, a barcode, a two-dimensional code (QR code (Registered Trademark)), or the like, which is readable by an optical means. The identification information may be printed with ink or drawn by a laser or the like. The identification information may be printed on a sticker and attached to the outer surface 40a.

The cover 31 has protrusions 43 (first protrusion), a protrusion 44 (second protrusion), protrusions 45 (second protrusion), and protrusions 46 (second protrusion) formed in the outer surface 40a of the side wall 40. In one example, the cover 31 has a pair of protrusions 43, one protrusion 44, a pair of protrusions 45, and a plurality of protrusions 46 (twenty two protrusions 46 in the present embodiment). The protrusions 43, 44, 45, 46 are integrally formed with the side wall 40.

The protrusions 43 protrude outward from the outer surface 40a along the Y-axis direction between the first holes 41 and the second holes 42. The protrusions 43 extend in the X-axis direction so as to partition between the first holes 41 from the second holes 42 in the vertical direction (Z-axis direction) as viewed in the Y-axis direction. The wording “protrusions 43 partitioning between the first holes 41 from the second holes 42 in the vertical direction” represents a state in which the protrusions 43 extend so as to block an imaginary straight line m1 connecting a center of one of the first holes 41 with a center of one of the second holes 42 closest to the one of the first holes 41, as illustrated in FIG. 10. Here, the center of each of the first holes 41 is, for example, the centroid of the opening shape thereof on the outer surface 40a. The center of each of the second holes 42 is, for example, the centroid of the opening shape thereof on the outer surface 40a.

More preferably, the protrusions 43 each extend so as to block both an imaginary straight line m2 connecting one end of one of the first holes 41 with one end of one of the second holes 42 in a direction intersecting the vertical direction (X-axis direction) as viewed in the Y-axis direction, and an imaginary straight line m3 connecting the other end of the one of the first holes 41 with the other end of the one of the second holes 42. As viewed in the Y-axis direction, the first holes 41 are positioned vertically below the protrusions 43, and the second holes 42 are located vertically above the protrusions 43. One protrusion 43 is provided for each of the attaching regions 24 (see FIG. 4). The paired protrusions 43 are spaced from each other in the X-axis direction.

As viewed in the Y-axis direction, a length L1 of each of the protrusions 43 in the X-axis direction is equal to or greater than a length L2 of each of the first holes 41 in the X-axis direction and is equal to or greater than a length L3 of each of the second holes 42 in the X-axis direction. The protrusions 43 extend so as to entirely cover upper sides of the first holes 41 and entirely cover lower sides of the second holes 42 as viewed in the Y-axis direction. In the present embodiment, the length L2 and the length L3 are equal to each other. The protrusions 43 are formed in length corresponding to the entire attaching regions 24 in the X-axis direction. That is, the length L1 is equal to the length of each of the attaching regions 24 in the X-axis direction. The protrusions 43 each have the length L1 that can cover all of the upper sides of the three first holes 41 and the lower sides of the three second holes 42 provided in each of the attaching regions 24.

The protrusion 44 has a frame shape so as to surround all of the plurality of first holes 41 and the plurality of second holes 42. The protrusion 44 is provided on the outer edge of the outer surface 40a of the side wall 40. The protrusion 44 includes a first side portion 44a, a second side portion 44b, and a pair of third side portions 44c.

The first side portion 44a and the second side portion 44b face each other in the Z-axis direction with the protrusions 43 disposed therebetween. The first side portion 44a is disposed vertically below the protrusions 43, and extends in the X-axis direction. As viewed in the Y-axis direction, the first holes 41 are located closer to the first side portion 44a than the protrusions 43 are. The second side portion 44b is disposed vertically above the protrusions 43, and extends in the X-axis direction. As viewed in the Y-axis direction, the second holes 42 are located closer to the second side portion 44b than the protrusions 43 are.

The paired third side portions 44c face each other in the X-axis direction. The paired third side portions 44c extend in the Z-axis direction and connect the first side portion 44a with the second side portion 44b. The third side portions 44c each are connected to one end of their associated one of the protrusions 43 in the X-axis direction.

The paired protrusions 45 are disposed respectively on opposite sides of the area in the center of the outer surface 40a in the X-axis direction where the first holes 41 and the second holes 42 are not provided. The paired protrusions 45 face each other in the X-axis direction. The protrusions 45 each extend vertically downward from the other end of their associated one of the protrusions 43 in the X-axis direction, and are connected to the first side portion 44a. The protrusion 44 and the protrusions 45 both have the same height as the protrusions 43. The height here refers to the height in the Y-axis direction with the outer surface 40a as a reference surface. The protrusions 43, the protrusion 44, and the protrusions 45 are formed so that the positions of their tips are aligned with each other in the Y-axis direction.

The protrusions 46 extend in the Z-axis direction and connect the protrusions 43 with the protrusions 44. Five protrusions 46, together with one protrusion 45, are arranged in the X-axis direction at positions vertically below one of the protrusions 43, and connect the one of the protrusions 43 with the first side portion 44a. Six protrusions 46 are arranged in the X-axis direction at positions vertically above one of the protrusions 43, and connect of the one of the protrusions 43 with the second side portion 44b. The protrusions 46 are provided between the first holes 41 and the second holes 42 adjacent to each other in the X-axis direction.

As illustrated in FIG. 11, the protrusions 45 and the protrusions 46 are disposed so as to be offset from the plurality of seal portions 39 as viewed in the compression direction (Y-axis direction) of the valve bodies 30. That is, as viewed in the Y-axis direction, the protrusions 45 and the protrusions 46 extend in the Z-axis direction between the seal portions 39 adjacent to each other in the X-axis direction. In one example, the entire sealing portions 39 protruding from the inner wall surface 32b do not have to be positioned offset from the protrusions 45 and the protrusions 46. At least portions of the seal portions 39 that can be in contact with the first end surfaces 30a of the valve bodies 30 need to be offset from the protrusions 45 and the protrusions 46.

A height of each of the protrusions 46 is smaller than those of the protrusions 43, the protrusion 44, and the protrusions 45. The height here refers to the height in the Y-axis direction with the outer surface 40a as a reference surface. Tips of the protrusions 46 are located closer to the outer surface 40a than those of the protrusions 43, the protrusion 44, and the protrusions 45. The protrusions 46 are provided, for example, to reinforce the side wall 40. The height of each of the protrusions 46 is set to a height necessary for reinforcing the side wall 40.

The protrusions 43, the protrusion 44, the protrusions 45, and the protrusions 46 are provided so as to divide the outer surface 40a into a lattice shape. A plurality of regions of the outer surface 40a divided in this manner includes a region having one first hole 41, a region having one second hole 42, and a region having neither a first hole 41 nor a second hole 42. It can be said that, as viewed in the Y-axis direction, the protrusions 43, the protrusion 44, the protrusions 45, and the protrusions 46 are provided so as to surround each of the first holes 41 and the second holes 42.

As described above, in the pressure control valves 22, when the pressure in the internal spaces V is lower than a set pressure, the pressure control valves 22 each are maintained in a valve closed state in which the through holes 33 are blocked by the valve bodies 30. When the pressure in the internal spaces V is increased and becomes greater than the set pressure, the valve bodies 30 are elastically deformed so as to be separated from the bottom wall 32, which results in a valve opened state in which blocking of the through holes 33 are released. As a result, gas from the internal spaces V flows to the space S2 formed between the partition walls 37 and the cover 31 through the gaps G (accommodation spaces S1). At this time, electrolyte may flow from the internal spaces V to the space S2 together with gas.

The pressure control valves 22 each have the first holes 41 and the second holes 42 positioned vertically above the first holes 41, which are formed in the outer surface 40a of the side wall 40 of the cover 31 of the housing 23. Therefore, the electrolyte is discharged in a dripping manner from the first holes 41 positioned vertically below. On the other hand, since gas such as hydrogen and oxygen generated in the module main body 20 is lighter than air, gas is discharged from the second holes 42 positioned vertically above. In this way, electrolyte is not discharged from the same hole as gas, so that electrolyte is less likely to scattered. In addition, the protrusions 43 protrude outward from the outer surface 40a of the side wall 40 between the first holes 41 and the second holes 42, and extend so as to partition between the first holes 41 and the second holes 42. In other words, the protrusions 43 are provided so as to be interposed between a discharge path for electrolyte discharged from the first holes 41 and a discharge path for gas discharged from the second holes 42. Therefore, even if gas is forcefully discharged from the second holes 42, gas is blocked by the protrusions 43 and is unlikely to blow against electrolyte discharged from the first holes 41. Accordingly, it is possible to suppress scattering of electrolyte caused by gas.

The length L1 of each of the protrusions 43 is equal to or greater than the length L2 of each of the first holes 41, and equal to or greater than the length L3 of each of the second holes 42. The protrusions 43 extend so as to entirely cover the upper sides of the first holes 41 and entirely cover the lower sides of the second holes 42 as viewed in the Y-axis direction. Therefore, gas discharged from the second holes 42 is further less likely to blow against electrolyte discharged from the first holes 41. As a result, scattering of the electrolyte is further suppressed.

The first holes 41 and the second holes 42 are arranged so as not to overlap with each other in the vertical direction. Since distances between the first holes 41 and the second holes 42 are increased, blowing of gas discharged from the second holes 42 against electrolyte discharged from the first holes 41 is further suppressed.

The cover 31 of the housing 23 further has the protrusion 44, the protrusions 45, the protrusions 46 as a plurality of protrusions protruding from the outer surface 40a of the side wall 40, which cooperate with the protrusions 43 to surround the first holes 41 and the second holes 42. The protrusion 44, the protrusions 45, the protrusions 46 are disposed so that the protrusion 44, the protrusions 45, the protrusions 46 cooperate with the protrusions 43 to surround each of the first holes 41 and the second holes 42. Therefore, gas discharged from the second holes 42 is less likely to spread to the surroundings. Thus, blowing of gas against electrolyte discharged from the first holes 41 is further suppressed.

The through holes 33 are arranged in the X-axis direction as viewed in the Y-axis direction. In contrast, if the second hole 42 is provided at only one location in the X-axis direction, the paths to the second hole 42 may become long depending on the through holes 33. Therefore, there is a risk that gas will be discharged from first holes 41 which are disposed in the middle of the paths to second hole 42. In each of the pressure control valves 22, not only the plurality of through holes 33 are arranged in the X-axis direction, but also a plurality of second holes 42 are arranged in the X-axis direction. Therefore, the paths from the through holes 33 to the second holes 42 may be shortened. As a result, discharging of gas, which has flowed in from each of the through holes 33, from the first holes 41 is suppressed.

The first holes 41 may be arranged in line in the X-axis direction as viewed in the Y-axis direction. This reduces the amount of electrolyte discharged from the first holes 41 as compared to a case where only one first hole 41 is provided. Therefore, in the power storage device 1 formed by stacking the power storage modules 4 in the vertical direction, a short circuit between the power storage modules 4 disposed side by side through electrolyte discharged from the pressure control valves 22 is less likely to occur.

The present invention is not limited to the above-described embodiment.

For example, the height of each of the protrusions 43 may be smaller or larger than the height of the protrusion 44. The protrusions 43 do not have to be provided over a length corresponding to the entire attaching regions 24 in the X-axis direction, and one protrusion 43 may be provided for each of the first holes 41.

The length L1 of each of the protrusions 43 may be less than the length L2 of each of the first holes 41, and may be less than the length L3 of each of the second holes 42. Even in this case, as long as the protrusions 43 are interposed between the first holes 41 and the second holes 42 as viewed in the Y-axis direction, it is possible to block at least a portion of gas discharged from the second holes 42. As a result, scattering of the electrolyte is further suppressed.

The first holes 41 and the second holes 42 may be arranged so as to overlap with each other as viewed in the vertical direction. The outer surface 40a of the side wall 40 does not necessarily have to have the protrusions 44, 45, and 46. Each of the number of the first holes 41 and the number of the second holes 42 only needs to be one or more.

The gist of the present is outlined as the following [1] to [6].
[1]A power storage module comprising: a module main body having an electrode stack in which a plurality of electrodes are stacked; and a pressure control valve attached to the module main body, wherein the pressure control valve includes: a housing having a first wall that has a communication hole in communication with an internal space formed between the electrodes, the internal space containing electrolyte, a second wall facing the first wall in a first direction that intersects with a vertical direction, and a first protrusion formed in the second wall; and a valve body accommodated in the housing so as to close the communication hole, the second wall has a first hole that provides communication between an inside and an outside of the housing and is opened at an outer surface of the second wall, and a second hole that provides communication between the inside and the outside of the housing is opened at the outer surface, the second hole being positioned vertically above the first hole, and the first protrusion protrudes outward from the outer surface along the first direction, and extends so as to partition between the first hole and the second hole, as viewed in the first direction.
[2] The power storage module according to [1], wherein a length of the first protrusion in a second direction intersecting with the vertical direction is equal to or greater than a length of the first hole and a length of the second hole in the second direction, as viewed in the first direction, and the first protrusion extends so as to entirely cover an upper side of the first hole and entirely cover a lower side of the second hole, as viewed in the first direction.
[3] The power storage module according to [1] or [2], wherein the first hole and the second hole are disposed so as not to overlap with each other in the vertical direction.
[4] The power storage module according any one of [1] to [3], wherein the housing includes a plurality of second protrusions formed in the outer surface, the second protrusions and the first protrusion cooperating to surround each of the first hole and the second hole.
[5] The power storage module according to any one of [1] to [4], wherein the internal space includes a plurality of the internal spaces, the communication hole includes a plurality of the communication holes arranged in a third direction intersecting with the vertical direction, as viewed in the first direction, the plurality of the communication holes being in communication with their associated plurality of the internal spaces, and the second hole includes a plurality of the second holes arranged in the third direction.
[6] The power storage module according to any one of [1] to [5], wherein the first hole includes a plurality of the first holes arranged in a third direction intersecting with the vertical direction, as viewed in the first direction.

Reference Signs List

| | |
|---|---|
| 4 | power storage module |
| 20 | module main body |
| 22 | pressure control valve |
| 23 | housing |
| 30 | valve body |
| 32 | bottom wall (first wall) |
| 33 | through hole (communication hole) |
| 40 | side wall (second wall) |
| 41 | first hole |
| 42 | second hole |
| 43 | protrusion (first protrusion) |
| 44, 45, 46 | protrusion (second protrusion) |
| V | internal space |

1. A power storage module comprising: a module main body having an electrode stack in which a plurality of electrodes are stacked; and a pressure control valve attached to the module main body, wherein
the pressure control valve includes:
a housing having a first wall that has a communication hole in communication with an internal space formed between the electrodes, the internal space containing electrolyte, a second wall facing the first wall in a first direction that intersects with a vertical direction, and a first protrusion formed in the second wall; and
a valve body accommodated in the housing so as to close the communication hole,
the second wall has a first hole that provides communication between an inside and an outside of the housing and is opened at an outer surface of the second wall, and a second hole that provides communication between the inside and the outside of the housing is opened at the outer surface, the second hole being positioned vertically above the first hole, and
the first protrusion protrudes outward from the outer surface along the first direction, and extends so as to partition between the first hole and the second hole, as viewed in the first direction.

2. The power storage module according to claim 1, wherein
a length of the first protrusion in a second direction intersecting with the vertical direction is equal to or greater than a length of the first hole and a length of the second hole in the second direction, as viewed in the first direction, and
the first protrusion extends so as to entirely cover an upper side of the first hole and entirely cover a lower side of the second hole, as viewed in the first direction.

3. The power storage module according to claim 1, wherein
the first hole and the second hole are disposed so as not to overlap with each other in the vertical direction.

4. The power storage module according to claim 1, wherein
the housing includes a plurality of second protrusions formed in the outer surface, the second protrusions and the first protrusion cooperating to surround each of the first hole and the second hole.

5. The power storage module according to claim 1, wherein
the internal space includes a plurality of the internal spaces,
the communication hole includes a plurality of the communication holes arranged in a third direction intersecting with the vertical direction, as viewed in the first direction, the plurality of the communication holes being in communication with their associated plurality of the internal spaces, and
the second hole includes a plurality of the second holes arranged in the third direction.

6. The power storage module according to claim 1, wherein
the first hole includes a plurality of the first holes arranged in a third direction intersecting with the vertical direction, as viewed in the first direction.
